(19) United States
(12) Patent Application Publication
(10) Pub. No.: US 2025/0309444 A1
(43) Pub. Date: Oct. 2, 2025

(54) PORTABLE CHARGING AND DISCHARGING INTEGRATED BATTERY ASSEMBLY

(71) Applicant: SHENZHEN ORIENTAL WILLING NEW ENERGY CO., LTD, Shenzhen (CN)

(72) Inventor: Kunli Wang, Shenzhen (CN)

(21) Appl. No.: 18/660,798

(22) Filed: May 10, 2024

(30) Foreign Application Priority Data
Mar. 29, 2024 (CN) 202420645637.5

(51) Int. Cl. H01M 50/247; H01M 10/42; H01M 50/244; H01M 50/256; H01M 50/271

(52) U.S. Cl. CPC H01M 50/247; H01M 10/425; H01M 50/244; H01M 50/256; H01M 50/271; H01M 2200/10

(57) ABSTRACT

This disclosure provides a portable charging and discharging integrated battery assembly including a lithium battery, a first charging cable, and a storage bag, the storage bag includes a bag body, a cover located at the top of the bag body, a sleeve opening provided on the side wall of the bag body, and a charging interface located on the side wall of the lithium battery, the lithium battery placed within the storage space with the charging interface exposed at the side wall of the bag body. The storage bag accommodates the connected lithium battery and charging cable without need for an additional storage bag, facilitating easy transport protecting the rechargeable lithium battery, preventing wear from direct contact with other items during transport, extending its lifespan and enhancing portability.

### TECHNICAL FIELD

This disclosure relates to the field of battery technology, and more particularly, to a portable charging and discharging integrated battery assembly.

### BACKGROUND

Rechargeable lithium batteries are one of the important energy supply devices for electronic products due to their stable voltage and current, reliable performance, convenience in portability, and simplicity in charging and discharging operations. They are widely used in various aspects of modern societal life.

As people's demands for a higher standard of living increase, particularly regarding the convenience and storage of portable products, rechargeable lithium batteries, which often need to be carried outdoors, require greater portability and storage capabilities. However, current rechargeable lithium batteries present significant inconveniences when taken outdoors, as users must temporarily find a storage bag for them. Some users even place the lithium batteries directly into a backpack, mixing them with other items. This can lead to entanglement of the USB cables with other objects and cause the batteries to collide and rub against other items, leading to loss of functionality. Thus, there is an urgent need to develop a device that facilitates the convenient carrying and storage of rechargeable lithium batteries to address these issues.

### SUMMARY

The objective of this disclosure is to overcome the deficiencies of the existing technologies by providing a portable charging and discharging integrated battery assembly.

This disclosure is realized by providing a portable charging and discharging integrated battery assembly that includes a lithium battery, a first charging cable, and a storage bag for accommodating the lithium battery and the first charging cable, the storage bag includes a bag body with a storage space and a cover at the top of the bag body that can open and close the storage space, a sleeve opening is provided on the side wall of the bag body, and a charging interface is provided on the side wall of the lithium battery, the lithium battery is positioned within the storage space with the charging interface exposed at the side wall of the bag body, the first charging cable is connected at the charging interface, and the first charging cable passes through the sleeve opening and is secured to the side wall of the bag body.

Specifically, the inner side of the cover is provided with a hook portion of a hook-and-loop fastener, and the outer side wall of the bag body is provided with a loop portion of the hook-and-loop fastener that adheres to the hook portion.

Specifically, two of the sleeve openings are provided and are spaced apart.

Specifically, the sleeve opening is fixed to the side wall of the bag body; alternatively, the sleeve opening is adhered to the side wall of the bag body using a hook-and-loop fastener.

Specifically, the cross-section of the sleeve opening is U-shaped and fixed to the side wall of the bag body; alternatively, the sleeve opening is formed by two connecting blocks adhered together to enclose the opening.

Specifically, the side wall of the bag body further has a hanging portion for suspending the storage bag.

Specifically, the bag body is cylindrical in shape; alternatively, the bag body is a flat rectangular shape.

Specifically, one end of the first charging cable is a TYPE-C connector, and the other end is an expandable plug-in socket, with the TYPE-C connector engaging with the charging interface and oriented perpendicular to the first charging cable.

Specifically, the integrated battery assembly further includes a second charging cable, where one end of the second charging cable connects to the plug-in socket of the first charging cable, and the other end of the second charging cable is a TYPE-C connector.

Specifically, one end of the first charging cable is a TYPE-C connector, and the other end is an Apple connector, the TYPE-C connector is engaged with the charging interface, oriented perpendicular to the first charging cable, and the Apple connector connects to a third charging cable, the other end of the third charging cable is a TYPE-C connector.

Specifically, a first snap-fit structure is further included, located at the lower end of the cover, in this embodiment, with the female part of the first snap-fit structure on the lower end of the cover and the male part on the bag body, positioned below the loop portion of the hook-and-loop fastener; the cover and the bag body are not only detachably connected via the hook-and-loop fastener but also via the first snap-fit structure, making the connection more secure.

Furthermore, referring to embodiment 3 where the handle is arranged on the bag body, in this embodiment 4, two connecting parts and a handle are fixedly connected to the bag body, one connecting part is located on one side of the bag body directly below the cover, and the other connecting part on the opposite side, one end of the handle is fixedly connected to one connecting part, and the other end extends to and is fixedly connected to the other connecting part. Users can carry the integrated battery assembly by the handle or hang it on hooks or other suitable hanging structures on the wall.

Implementing this disclosure provides the following beneficial effects:

In this disclosure, by placing the rechargeable lithium battery inside the bag body, covering the rechargeable lithium battery with the cover at the top, and securing the charging cable connected to the lithium battery to the side wall of the bag body, the lithium battery and its connected charging cable are stored in the storage bag during charging/discharging. Users do not need to find a separate storage bag when carrying the rechargeable lithium battery, and the storage bag further protects the battery from wear and tear during transport, thereby extending its lifespan and making it easy to carry.

Additionally, the integrated battery assembly is provided with a first snap-fit structure, making the connection between the cover and the bag body more robust. The integrated battery assembly further includes a handle, allowing users to carry the integrated battery assembly by hand or hang it on wall hooks or other suitable structures for hanging.

### BRIEF DESCRIPTION OF THE DRAWINGS

To more clearly illustrate the technical solutions in the embodiments of this disclosure or in existing technology, the following provides a brief introduction to the drawings needed for the descriptions of these embodiments or existing technology. It is evident that the drawings described below are only some embodiments of this disclosure. For those skilled in the art, additional drawings can be derived from these without the need for creative labor. Included are:

FIG. 1 is a schematic diagram of the structure of the portable charging and discharging integrated battery assembly in Embodiment 1 of this disclosure.

FIG. 2 is an exploded schematic diagram of the portable charging and discharging integrated battery assembly in Embodiment 1 of this disclosure.

FIG. 3 is a schematic diagram of the structure of the portable charging and discharging integrated battery assembly in Embodiment 2 of this disclosure.

FIG. 4 is an exploded schematic diagram of the structure of the portable charging and discharging integrated battery assembly in Embodiment 2 of this disclosure.

FIG. 5 is another schematic diagram of the structure of the portable charging and discharging integrated battery assembly in Embodiment 2 of this disclosure.

FIG. 6 is a side view of the portable charging and discharging integrated battery assembly in Embodiment 2 of this disclosure.

FIG. 7 is a sectional schematic diagram of the storage bag of the portable charging and discharging integrated battery assembly in Embodiment 2 of this disclosure.

FIG. 8 is a detailed enlargement of part A from FIG. 7 in Embodiment 2 of this disclosure.

FIG. 9 is a schematic diagram of the high-temperature alarm circuit in the portable charging and discharging integrated battery assembly in Embodiment 2 of this disclosure.

FIG. 10 is a front perspective view of the high-temperature alarm circuit in the portable charging and discharging integrated battery assembly in Embodiment 4 of this disclosure.

FIG. 11 is a rear perspective view of the high-temperature alarm circuit in the portable charging and discharging integrated battery assembly in Embodiment 4 of this disclosure.

The reference numerals in the drawings are as follows:
10—Lithium battery; 11—Charging interface;
20—First charging cable; 21—TYPE-C connector; 22—Plug-in socket; 23—Apple connector;
30—Storage bag; 31—Bag body; 32—cover; 321—First snap-fit structure; 322—Third snap-fit structure, 33—Sleeve opening; 331—Connecting block; 34—Hanging portion; 35—Heat dissipation hole; 36—Handle; 37—Connecting part; 38—Second snap-fit structure; 39—Outer layer; 310—Filling layer; 311—Inner layer;
40—Second charging cable; 50—Third charging cable; 60—Splitter; 70—High-temperature alarm device.

### DETAILED DESCRIPTION

In order to make the technical problems, technical solutions and beneficial effects to be solved by the present disclosure clearer, the present disclosure is hereinafter described in further detail in combination with the accompanying drawings and embodiments. It should be understood that the specific embodiments described herein are only for the purpose of explaining the present disclosure and are not intended to limit the present disclosure.

It should be appreciated that when an element is recited to be “fixed to” or “mounted to” another element, it means that this element can be directly or indirectly fixed to another element. It should be appreciated that when an element is recited to be “connected to” another element, it means that this element can be directly or indirectly connected to another element.

It is to be understood that orientations or positional relationships described by terms such as “length”, “width”, “upper”, “low”, “forward”, “back”, “left”, “right”, “vertical”, “horizontal”, “top”, “bottom”, “inside”, “outside” indicate orientations or positional relationships shown in the accompanying drawings, which are intended only to facilitate the description of this disclosure and are not intended to indicate or imply particular orientations of devices or elements in the embodiments or operations depending on particular orientations of them, and therefore are not intended to limit the present disclosure.

Furthermore, terms “first” and “second” are used only for descriptive purposes, and are not to be construed as indicating or implying preferability or implicitly specifying number of technical features indicated. A feature defined with “first” or “second” may explicitly or implicitly means one or more features. In this disclosure, term “a plurality of” means two and more, and term “several” means one or more, unless otherwise expressly and specifically limited.

This application provides a portable charging and discharging integrated battery assembly, which includes a lithium battery, a first charging cable, and a storage bag for accommodating the lithium battery and the first charging cable. The storage bag comprises a bag body with a storage space and a cover at the top of the bag body that can open and close this storage space. A sleeve opening is provided on the side wall of the bag body, and a charging interface is located on the side wall of the lithium battery. The lithium battery is placed within the storage space with the charging interface exposed at the side wall of the bag body. The first charging cable is connected to the charging interface and passes through the sleeve opening, affixed to the side wall of the bag body.

By placing the rechargeable lithium battery inside the bag body, covering it with the cover at the top, and securing the charging cable connected to the lithium battery to the side wall of the bag body, this application allows for easy storage of the lithium battery and its connected charging cable. When carrying the rechargeable lithium battery, users do not need to find a separate storage bag, and the storage bag further protects the lithium battery from wear and tear during transport, thereby extending its lifespan and enhancing portability.

The specific embodiments of this application are further described below with reference to the accompanying drawings.

### Embodiment 1

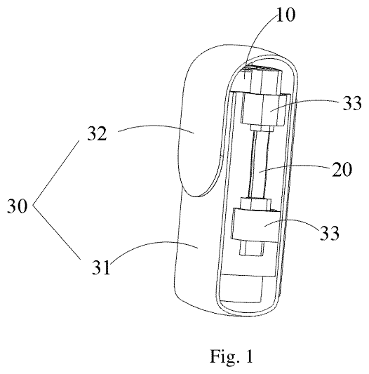

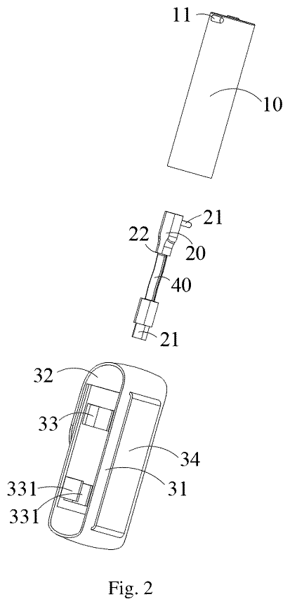

Referring to FIGS. 1 and 2, Embodiment 1 of this application provides a portable charging and discharging integrated battery assembly, which includes a lithium battery 10, a first charging cable 20, and a storage bag 30 for accommodating the lithium battery 10 and the first charging cable 20. The storage bag 30 comprises a bag body 31 and a cover 32 located at the top of the bag body 31, where the bag body 31 has a storage space, and the cover 32 can be flipped open/closed to access this space. On the side wall of the bag body 31, there is a sleeve opening 33, and on the side wall of the lithium battery 10, there is a charging interface 11. The lithium battery 10 is placed within the storage space with the charging interface 11 exposed at the side wall of the bag body 31. The first charging cable 20 is connected to the charging interface 11, and passes through the sleeve opening 33 and is affixed to the side wall of the bag body 31.

In this embodiment, the bag body 31 is in a flat rectangular shape. On the inner side of the cover 32 is the hook portion of a hook-and-loop fastener (not shown in the figures), and on the external side wall of the bag body 31 is the loop portion of the hook-and-loop fastener (also not shown) that adheres to the hook portion. The storage bag 30 is conveniently opened and closed using the hook-and-loop fastener.

Additionally, a hanging portion 34 is further provided on the side wall of the bag body 31, which allows the storage bag 30 to be hung on an external support, facilitating easy carrying and securing.

In this embodiment, there are two sleeve openings 33, spaced apart and located near the upper and lower parts of the side wall of the bag body 31. Both sleeve openings 33 are fixed to the side wall of the bag body 31 and have a U-shaped cross-section. The upper sleeve opening 33 is a complete U-shape through which the first charging cable 20 directly passes; the lower sleeve opening 33 is formed by two connecting blocks 331 that are adhesively joined, allowing the sleeve opening 33 to be opened by separating the two connecting blocks 331, placing the charging cable inside, and then re-securing the blocks.

In this embodiment, one end of the first charging cable 20 is a TYPE-C connector 21, and the other end is an expandable plug-in socket 22, where the TYPE-C connector 21 engages with the charging interface 11 of the lithium battery 10, and is oriented perpendicular to the first charging cable 20. Additionally, a second charging cable 40 extends from the plug-in socket 22, where one end of the second charging cable 40 connects to the plug-in socket of the first charging cable 20, and the other end of the second charging cable 40 is also a TYPE-C connector 21. Certainly, according to needs, any other types of connectors can be expanded at the plug-in socket.

### Embodiment 2

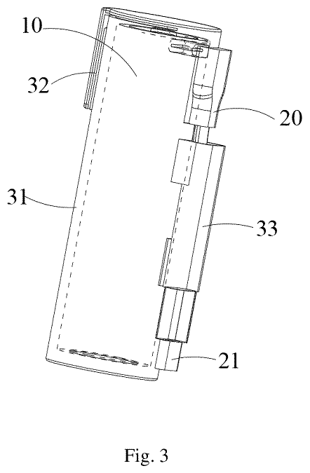

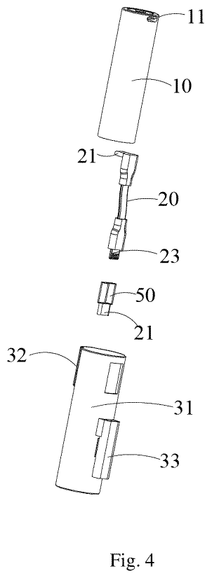

Referring to FIGS. 3 and 4, Embodiment 2 of this application provides a portable charging and discharging integrated battery assembly, which differs from Embodiment 1 in the shape of the bag body 31. In this embodiment, the bag body 31 is cylindrical, and there is one sleeve opening 33 which is attached to the side wall of the bag body 31 using hook-and-loop fastener. Thus, the position of the sleeve opening 33 can be moved as needed.

Another difference from Embodiment 1 in this embodiment is the configuration of the charging cables. In this embodiment, one end of the first charging cable 20 is a TYPE-C connector 21, and the other end is an Apple connector 23. The TYPE-C connector 21 engages with the charging interface 11, and is oriented perpendicular to the first charging cable 20. The Apple connector 23 is connected to a third charging cable 50, the other end of which is also a TYPE-C connector 21.

Certainly, the structure of the charging cables in this embodiment can be interchangeable with those in Embodiment 1, or can be expanded to other charging cable configurations.

### Embodiment 3

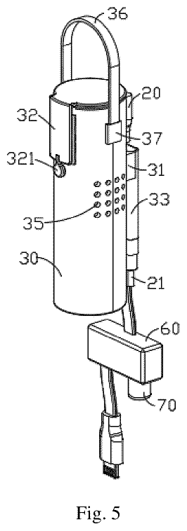

As shown in FIGS. 5 to 9, based on improvements from Embodiment 2, this portable charging and discharging integrated battery assembly includes additional features at the upper end of the bag body 31, specifically two connecting parts 37 and a handle 36. The two connecting parts 37 are symmetrically placed on opposite sides of the cover 32; the ends of the handle 36 are fixedly connected to these two connecting parts 37. The handle 36 facilitates the easy removal of the lithium battery 10 from a bag or other storage space.

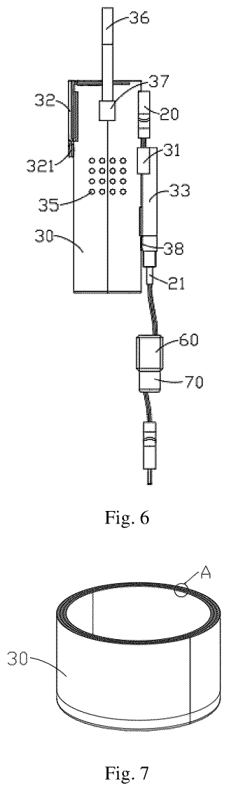

As illustrated in FIGS. 5 and 6, the lower end of the cover 32 is provided with a first snap-fit structure 321. The female part of this first snap-fit structure 321 is located on the lower end of the cover 32, while the male part is located on the bag body 31, directly below the loop portion of the hook-and-loop fastener. When the lithium battery 10 is placed inside the bag body 31 and covered with the cover 32, the hook portion of the hook-and-loop fastener on the cover 32 is adhered to the loop portion, and then the first snap-fit structure 321 is engaged by aligning and connecting its female and male parts. This connection further secures the cover 32 to the bag body 31, enhancing the stability of their attachment.

Further improvements include a second snap-fit structure 38 at the lower end of the sleeve opening 33. The female part of the second snap-fit structure 38 is located at the tail end of the lower part of the sleeve opening 33, while the male part is located on the bag body 31. After the sleeve opening 33 is attached to the bag body 31 using another piece of hook-and-loop fastener, the second snap-fit structure 38 is engaged by aligning and connecting its female and male parts. This mechanism further strengthens the attachment of the sleeve opening 33 to the bag body 31, ensuring a more robust connection.

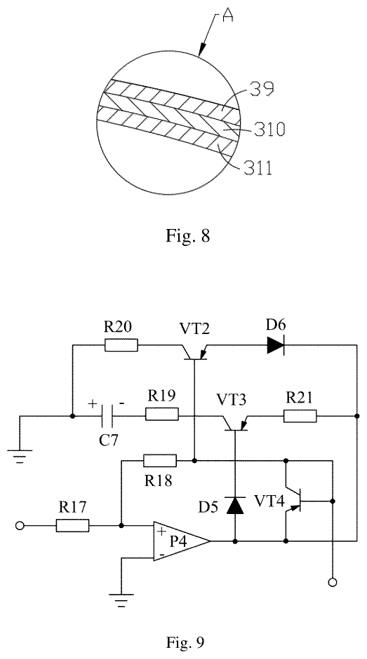

Referring to FIGS. 7 and 8, the bag body 31 comprises an outer layer 39, a filling layer 310, and an inner layer 311, with the filling layer 310 positioned between the outer layer 39 and the inner layer 311. Both the outer layer 39 and the inner layer 311 are made from flexible materials with insulating properties, such as polyurethane, fiberglass felt, or asbestos felt. The filling layer 310 has cushioning properties and thermal insulation qualities, being composed of a mix of cushioning and insulating materials, designed to absorb impacts and provide thermal isolation from external conditions.

As shown in FIGS. 5 and 6, the bag body 31 also features heat dissipation holes 35 that allow heat generated by the lithium battery 10 to be dissipated promptly.

Preferably, the integrated battery assembly includes a high-temperature alarm device 70. This device activates to emit an over-temperature warning when the lithium battery 10 heats up to a set temperature threshold, alerting the user to address and manage this high-temperature condition promptly to prevent the risk of the lithium battery 10 exploding due to excessive heat.

Another preference is that the storage bag 30 includes a splitter 60. One end of the splitter 60 is provided with a connector for a USB port leading from the rechargeable lithium battery 10, while the other end has two interfaces. One connects to the high-temperature alarm device 70 and the other to a USB cable that can be used to connect electronic devices.

As shown in FIG. 9, the circuit of the high-temperature alarm device 70 is illustrated. The high-temperature alarm device 70 operates such that when the ambient temperature around the rechargeable lithium battery 10 exceeds a certain threshold, such as 50° C., it emits a high-temperature warning signal. This alerts the user to take immediate action to prevent the risk of the lithium battery 10 exploding due to excessive heat.

### Embodiment 4

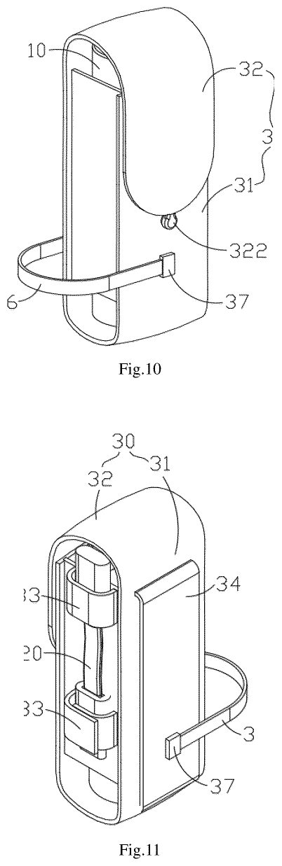

Referring to FIGS. 10 and 11, making further improvements from Embodiment 1, the portable charging and discharging integrated battery assembly, as referenced in Embodiment 3, incorporates a third snap-fit structure 322 at the lower end of the cover 32 in Embodiment 4. The female part of the third snap-fit structure 322 is positioned at the lower end of the cover 32, and the male part is situated on the bag body 31, directly below the loop portion of the hook-and-loop fastener. In addition to the detachable connection via the hook-and-loop fastener, the cover 32 can also be detachably connected to the bag body 31 using the third snap-fit structure 322, thus enhancing the robustness of the connection.

Moreover, taking cue from the handle 36 setup in Embodiment 3, in Embodiment 4, two connecting parts 37 and a handle 36 are also fixedly connected to the bag body 31. One connecting part 37 is located on one side of the bag body 31 directly below the cover 32, while the other connecting part 37 is positioned on the opposite side of the bag body 31. One end of the handle 36 is fixedly connected to one of the connecting parts 37, with the other end extending to and fixedly connected to the other connecting part 37. This setup allows users to easily lift the integrated battery assembly by the handle or hang it on wall hooks or other suitable hanging structures.

The foregoing description are only embodiments of the present disclosure, but the scope of protection of the present disclosure is not limited thereto, and any technician skilled in the art can easily think of changes or substitutions within the scope of the technology disclosed in the present disclosure, all of which should be covered by the scope of protection of the present disclosure.

1. A portable charging and discharging integrated battery assembly, comprising:
a lithium battery,
a first charging cable, and
a storage bag for accommodating the lithium battery and the first charging cable,
wherein the storage bag comprises a bag body having a storage space and a cover located at a top of the bag body for opening and closing the storage space, a sleeve opening is provided on a side wall of the bag body, a charging interface is located on a side wall of the lithium battery, wherein the lithium battery is positioned within the storage space with the charging interface exposed at the side wall of the bag body, the first charging cable is connected to the charging interface, and the first charging cable passes through the sleeve opening and is secured to the side wall of the bag body.

2. The portable charging and discharging integrated battery assembly of claim 1, wherein an inner side of the cover comprises a hook portion of a hook-and-loop fastener, and an outer side wall of the bag body comprises a loop portion of the hook-and-loop fastener that adheres to the hook portion.

3. The portable charging and discharging integrated battery assembly of claim 1, wherein two of the sleeve openings are provided and are spaced apart.

4. The portable charging and discharging integrated battery assembly of claim 1, wherein the sleeve opening is fixed to the side wall of the bag body; alternatively, the sleeve opening is adhered to the side wall of the bag body via a hook-and-loop fastener.

5. The portable charging and discharging integrated battery assembly of claim 1, wherein the sleeve opening has a U-shaped cross-section; alternatively, the sleeve opening is formed by two connecting blocks adhered together to enclose the opening.

6. The portable charging and discharging integrated battery assembly of claim 1, wherein a hanging portion is provided on the side wall of the bag body for suspending the storage bag;
the integrated battery assembly further comprises a first snap-fit structure located at a lower end of the cover, a female part of the first snap-fit structure is located at the lower end of the cover, and a male part of the first snap-fit structure is located on the bag body directly below the loop portion of the hook-and-loop fastener; the cover is detachably connected to the bag body not only by the hook-and-loop fastener but also by the first snap-fit structure;
the integrated battery assembly further comprises two connecting parts and a handle, wherein one connecting part is located on one side of the bag body directly below the cover, and the other connecting part is located on an opposite side of the bag body, one end of the handle is fixedly connected to one of the two connecting parts, and the other end of the handle extends to and is fixedly connected to the other connecting part.

7. The portable charging and discharging integrated battery assembly of claim 1, wherein the bag body is cylindrical in shape; alternatively, the bag body is a flat rectangular shape.

8. The portable charging and discharging integrated battery assembly of claim 1, wherein one end of the first charging cable is a TYPE-C connector, and the other end is an expandable plug-in socket, the TYPE-C connector being engaged with the charging interface, and the TYPE-C connector is oriented perpendicularly to the first charging cable.

9. The portable charging and discharging integrated battery assembly of claim 8, further comprising a second charging cable, wherein one end of the second charging cable is connected to the plug-in socket of the first charging cable, and the other end of the second charging cable is a TYPE-C connector.

10. The portable charging and discharging integrated battery assembly of claim 1, wherein one end of the first charging cable is a TYPE-C connector and the other end is an Apple connector, the TYPE-C connector being engaged with the charging interface, the TYPE-C connector is oriented perpendicularly to the first charging cable, the Apple connector is connected to a third charging cable, and the other end of the third charging cable is a TYPE-C connector.
